(19) United States
(12) Patent Application Publication
(10) Pub. No.: US 2007/0090606 A1
(43) Pub. Date: Apr. 26, 2007

(54) Low wear piston sleeve

(75) Inventors: Bradley A. Ross, Los Olivos, CA (US); Michael L. Brest, Goleta, CA (US); Sunder S. Rajan, Anaheim, CA (US)

Correspondence Address: Raytheon Company;Intellectual Property & Licensing, 2000 East El Segundo Boulevard, EO/E04/N119, PO Box 902, El Segundo, CA, 90254-0902, US

(73) Assignee: Raytheon Company, a corporation of the state of Delaware

(21) Appl. No.: 11/255,432

(22) Filed: Oct. 20, 2005

(51) Int. Cl. F25B 9/00; F16J 15/00

(52) U.S. Cl. 277/500; 62/6; 277/585

(57) ABSTRACT

Provided is a low friction, self-lubricating sleeve for use with a reciprocating piston in the compressor and/or the expander subsystem of a cryogenic cooler or other compressor type system. The sleeve is bonded to an outer surface of the piston, thereby positioning the sleeve between the piston and an inner wall of a piston cylinder. The sleeve is manufactured using a polyetheretherketone base material, as well as varying percentages of carbon and/or polytetrafluoroethylene fillers. The sleeve may include a dry lubricant such as graphite or molybdenum disulfide, and may extend for all or part of the length of the piston. The sleeve demonstrates negligible wear over thousands of hours of use in the cryogenic cooler, thereby minimizing system gas blow-back and maximizing system efficiency/performance.

### FIELD OF THE INVENTION

This invention relates generally to clearance seals for use in cryogenic coolers and other compressor type devices. More particularly, this invention relates to a low friction, low wear, self-lubricating sleeve that is part of a clearance seal for use in the compressor and expander subsystems of Stirling cycle cryogenic coolers.

### BACKGROUND

In general, Stirling cycle cryogenic coolers (“cryocoolers”) include both a compressor chamber or subsystem and an expander chamber or subsystem. Both subsystems may include a reciprocating piston assembly with a bonded (or otherwise mounted) sleeve, wherein the pistons are driven by a mechanical, an electrical, or a pneumatic drive mechanism. Operation of the piston(s) concertedly compresses and expands helium gas contained within the cooler, thereby achieving the thermodynamic cooling cycle desired. The gap between the piston assembly and the cylinder is small, forming a clearance seal to minimize pumping losses, or blowby.

Typically, the operational lifetime of Stirling cryocoolers, in tactical or other applications, is limited by performance degradation over time due to wear of the piston or sleeves. Quite often, the side loads experienced by the piston, and hence the seal, in the compressor are greater than those imposed on the expander piston. As such, the seal in the compressor subsystem tends to wear faster, and is therefore a more defining factor in establishing the operational parameters of the cryocooler. Nonetheless, wear on either the compressor or expander seal can degrade performance, reduce efficiency, and shorten the operational lifetime of the cryocooler.

Referring to FIG. 1, a cut-away view of a portion of a compressor subsystem 100 is presented. A piston 102 having a bonded sleeve 104 is positioned within a cylinder 106 of subsystem 100. Currently, sleeves are manufactured from one of several materials, to include: Rulon J™, Fluorogold™, ceramics, and polyphenylene sulfide combined with carbon, graphite and/or polytetrafluoroethylene (e.g. PTFE or Teflon™). In the manufacture of a compressor subsystem, e.g. subsystem 100, the piston 102/sleeve 104 combination is machined to very tight tolerances in order to match the outer surface 108 of sleeve 104 to the machined inner surface 110 of cylinder 106. Typically, the gap 112 (or clearance seal) between surfaces 108 and 110 is on the order of 0.00025-0.0005 inches. NOTE: the dimensions of the gap, etc. depicted in each Figure are exaggerated for clarity.

As represented by arrow 114, piston 102 reciprocates in operation, during which time surfaces 108 and 110 contact one another. Over time, surface 108 abrades, creating a larger gap 116 and leading to greater gas blow-by. Further, as shown in FIG. 1, a layer 118 of sleeve 104 material may be deposited onto the inner surface 110 of cylinder 106. Gap 116, deposited layer 118, and debris resulting from sleeve 104 abrasion all reduce cryocooler performance, eventually dropping the performance below a minimum acceptable threshold.

Hence, there is a need for a sleeve in a cryocooler or other system that overcomes one or more of the drawbacks identified above.

### SUMMARY

The sleeve herein discloses advances in the art and overcomes problems articulated above by providing a sleeve for sealing an interface between two relatively movable members including: a polyetheretherketone base material; and a filler material.

In another embodiment, a method for manufacturing a sleeve for use with a reciprocating piston is provided, the method including: selecting a polyetheretherketone thermoplastic as a base material for the sleeve; combining a carbon filler material with the polyetheretherketone thermoplastic, wherein the carbon filler is 30% or less, by volume, of the sleeve; and combining a polytetrafluoroethylene filler with the polyetheretherketone thermoplastic, wherein the polytetrafluoroethylene filler is 30% or less, by volume, of the sleeve.

In yet another embodiment, an improved cryogenic cooler is provided having a compressor subsystem with a first reciprocating piston positioned within a first chamber in the compressor subsystem, and an expander subsystem with a second reciprocating piston positioned within a second chamber in the expander subsystem, the improvement including: a first self-lubricating, polyetheretherketone sleeve concentrically bonded to the first reciprocating piston and positioned between the first piston and an inner surface of the first chamber in the compressor subsystem; and a second self-lubricating, polyetheretherketone sleeve concentrically bonded to the second reciprocating piston and positioned between the second piston and an inner surface of the second chamber in the expander subsystem.

### BRIEF DESCRIPTION OF THE DRAWINGS

FIG. 1 is a partially cut-away view of a piston in a cylinder of a cryocooler; and

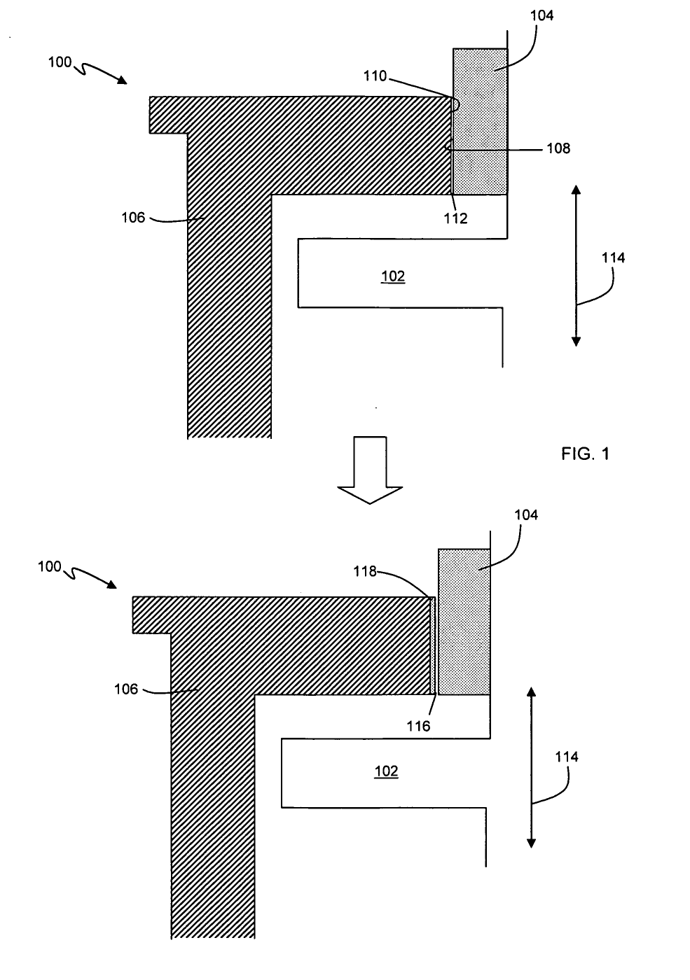

FIG. 2 is a partially cut away view of a cryocooler having an improved performance sleeve according to one environment of the present invention.

### DETAILED DESCRIPTION

Before proceeding with the detailed description, it should be noted that the present teaching is by way of example, not by limitation. The concepts herein are not limited to use or application with one specific type of sleeve or cryocooler. Thus, although the instrumentalities described herein are for the convenience of explanation, shown and described with respect to exemplary embodiments, the principles herein may be equally applied in other types of sleeves.

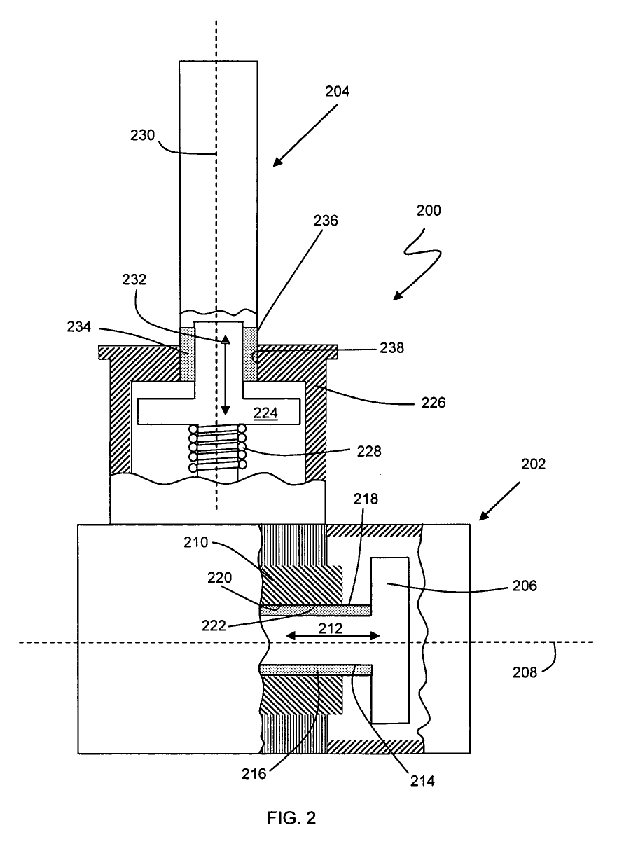

FIG. 2 shows a partially cut-away, simplified, view of a cryogenic cooler or cryocooler 200. Of note, cryocooler 200 may be any of a type well known in the art which includes at least one piston moving within a cylinder or other chamber. In at least one embodiment, cryocooler 200 is a Stirling cryogenic cooler, a type of cryocooler known to those skilled in the art. As shown, cryocooler 200 may include a compressor subsystem 202 and an expander subsystem 204. The compressor subsystem 202 and expander subsystem 204 may be physically integrated and positioned as shown in FIG. 2, or alternatively they may be integrated in any number of ways well known in the art.

Considering compressor subsystem 202 in greater detail, a reciprocating piston 206, defining a longitudinal centerline 208, is positioned within a cylinder 210 or other containment chamber. In at least one embodiment, cylinder 210 is a stainless steel. Piston 206 may be any of a type of piston used in cryogenic coolers and the like. Attached to at least a portion of an outer surface 214 of piston 206 is a low friction, low wear, self-lubricating sleeve 216. Sleeve 216 may be bonded to piston 206, or it may be otherwise mechanically fastened to surface 214. In this context, the term “self-lubricating” indicates a sleeve material that inherently maintains a low coefficient of friction (“CoF”) relative to the CoF of the cylinder or other sleeve materials, without the use of lubricants.

The interface between an outer surface 218 of sleeve 216 and an inner surface 220 of cylinder 210 is defined by precisely machining both surfaces 218, 220 to provide an interface gap 222 (or clearance seal) on the order of 0.0005 inches. Further, the concentricity of cylinder 210 and sleeve 216, and therefore surfaces 218 and 220, is tightly controlled to maintain a uniform interface between surfaces 218, 220. Sleeve 216 may extend for an entire length of piston 206, or for a portion thereof.

In operation, piston 206 moves back and forth along centerline 208, as represented by arrow 212. Bonded sleeve 216 moves in concert with piston 206, thereby causing surfaces 218 and 220 to rub against one another and potentially wear. Contact between surfaces 218, 220 creates frictional forces and the potential for wear of surface 218. As discussed in greater detail below, sleeve 216, with and without the use of a solid lubricant, minimizes wear and maximizes system performance when compared with seals previously used in cryogenic coolers or other compressor type systems.

In at least one embodiment, expander subsystem 204 also includes a reciprocating piston 224 positioned within a cylinder 226 or other chamber. Similar in composition to cylinder 210, cylinder 226 may be stainless steel. Piston 224, as well as piston 206, may be mechanically actuated with or without the use of a spring mechanism 228. Further, pistons 206, 224 may be reciprocated using a pneumatic device (not shown), electric motor (not shown), crankshaft (not shown), etc. Actuation of piston 224 induces movement along a centerline 230, in the directions indicated by arrow 232.

Attached to piston 224 may be yet another low friction, low wear sleeve 234, which may be bonded or otherwise permanently attached to the piston 224. An outer surface 236 of sleeve 234 interfaces with an inner surface 238 of cylinder 226, in much the same manner as sleeve 216 interfaces with cylinder 210. The same degree of care is required to ensure proper clearance, alignment and concentricity between components, i.e. piston 224, sleeve 234 and cylinder 226.

Operation of piston 224 is similar to that of piston 206. Specifically, as piston 224 moves within cylinder 226, surface 236 of sleeve 234 repeatedly contacts inner surface 238 of cylinder 226. Contact between surfaces 236, 238, and the resulting frictional forces, create a situation wherein prior art seals may tend to wear. Sleeve 234, however, demonstrates no appreciable wear during hours of operation numbering in the thousands. For example, in over 2000 hours of testing no measurable wear was detected on a sleeve such as sleeve 216, which is to say the wear, if any, was within the accuracy of the measurement device used for this type of measurement by those skilled in the art.

The absence of appreciable wear, of either clearance sleeve 216 or sleeve 234, is attributable to the material composition of the sleeves 216, 234. In particular, clearance sleeves 216 and 234 are manufactured using a base thermoplastic material, specifically polyetheretherketone (“PEEK”). In one embodiment, the PEEK is a LCL 4033™ material. In at least one embodiment, a carbon (or graphite) in the form of fiber or powder filler or polytetrafluoroethylene (e.g. PTFE of Teflon) filler is added to the base PEEK. In yet another embodiment, both carbon fillers and polytetrafluoroethylene fillers are used. The percentage of each material used in the manufacture of the clearance sleeves 216, 234 may be tightly controlled to provide the desired material characteristics. Typically, the material compositions are in the ranges of: 50-90% PEEK, 5-30% carbon (or graphite) in the form of fiber or powder filler, and 5-30% polytetrafluoroethylene filler, although other combinations of the three materials may be used. Sleeves 216, 234 manufactured using the materials disclosed above exhibit excellent strength, stiffness and machineability, as well as an acceptably low coefficient of friction and surface wear.

In addition, the sleeves of the present disclosure may include a dry lubricant applied to surfaces 218 and 236 to reduce the coefficient of friction of these surfaces. In one embodiment, the dry lubricant is a graphite lubricant. In yet another embodiment, the lubricant is a molybdenum disulfide. Selection of material compositions and external lubricants is dependent upon operational needs, defined system level parameters, and environmental constraints. It can be appreciated that sleeves 216, 234 may also be used in applications other than cryogenic coolers, e.g. any application requiring a low CoF, low wear sleeve.

Changes may be made in the above methods, devices and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, device and structure, which, as a matter of language, might be said to fall therebetween.

What is claimed is:

1. A sleeve for sealing an interface between two relatively movable members comprising:
a polyetheretherketone base material; and
a filler material.

2. The sleeve of claim 1, wherein the filler material is a carbon fiber.

3. The sleeve of claim 1, wherein the filler material is a polytetrafluoroethylene material.

4. The sleeve of claim 1, wherein the filler material includes a carbon fiber material and a polytetrafluoroethylene material.

5. The sleeve of claim 4, further comprising polyetheretherketone in the range of 50-90%, carbon filler in the range of 5-30%, and polytetrafluoroethylene in the range of 5-30%.

6. The sleeve of claim 5, further comprising 70% polyetheretherketone, 15% carbon filler, and 15% polytetrafluoroethylene filler.

7. The sleeve as in claims 1, 2, 3, or 4, further comprising a dry lubricant disposed in the interface.

8. The sleeve of claim 7, wherein the dry lubricant is graphite.

9. The sleeve of claim 7, wherein the dry lubricant is molybdenum disulfide.

10. A method for manufacturing a sleeve for use with a reciprocating piston, the method comprising:
selecting a polyetheretherketone thermoplastic as a base material for the sleeve;
combining a carbon filler material with the polyetheretherketone thermoplastic, wherein the carbon filler is 30% or less, by volume, of the sleeve; and
combining a polytetrafluoroethylene filler with the polyetheretherketone thermoplastic, wherein the polytetrafluoroethylene filler is 30% or less, by volume, of the sleeve.

11. The method of claim 10, further comprising applying a dry lubricant to an interface between the sleeve and the reciprocating piston to reduce the coefficient of friction therein.

12. The method of claim 11, wherein the dry lubricant is a graphite material.

13. The method of claim 11, wherein the dry lubricant is molybdenum disulfide.

14. In an improved cryogenic cooler having a compressor subsystem including a first reciprocating piston positioned within a first chamber in the compressor subsystem, and an expander subsystem including a second reciprocating piston positioned within a second chamber in the expander subsystem, the improvement comprising:
a first self-lubricating, polyetheretherketone sleeve concentrically bonded to the first reciprocating piston and positioned between the first piston and an inner surface of the first chamber in the compressor subsystem; and
a second self-lubricating, polyetheretherketone sleeve concentrically bonded to the second reciprocating piston and positioned between the second piston and an inner surface of the second chamber in the expander subsystem.

15. The cooler of claim 14, further comprising a carbon filler combined with the polyetheretherketone.

16. The cooler of claim 14, further comprising a polytetrafluoroethylene filler combined with the polyetheretherketone.

17. The cooler of claim 14, further comprising a carbon filler and a polytetrafluoroethylene filler combined with the polyetheretherketone.

18. The cooler of claim 17, further comprising 70% polyetheretherketone, 15% carbon filler, and 15% polytetrafluoroethylene filler.

19. The cooler as in claims 14, 15, 16 or 17, further comprising a dry lubricant applied to interfaces between the first and the second self-lubricating, polyetheretherketone sleeves and the first and the second reciprocating pistons respectively.

20. The cooler of claim 19, wherein the dry lubricant is selected from a group consisting of: graphite or molybdenum disulfide.
